(19) United States
(12) Patent Application Publication
(10) Pub. No.: US 2025/0240652 A1
(43) Pub. Date: Jul. 24, 2025

(54) ANALYSIS OF COMMUNICATION OPERATIONS IN A SIMULATED ENVIRONMENT

(71) Applicant: DISH Wireless L.L.C., Englewood, CO (US)

(72) Inventor: Praveen Mada, Denver, CO (US)

(21) Appl. No.: 18/417,400

(22) Filed: Jan. 19, 2024

(51) Int. Cl. H04W 24/06; H04L 41/16; H04W 24/02; H04W 28/02

(52) U.S. Cl. CPC H04W 24/06; H04L 41/16; H04W 24/02; H04W 28/0226

(57) ABSTRACT

An apparatus comprises a memory and a processor communicatively coupled to one another. The processor may be configured to perform communication operations in accordance with existing configuration commands and determine simulation parameters based on the communication operations. Further, the processor is configured to generate a simulated performance of the apparatus over a period of time in the simulated environment in response to executing a machine learning algorithm, compare the simulated performance to an expected performance of the apparatus, and determine multiple possible modifications to the existing configuration commands in response to determining whether the simulated performance does not match the expected performance. The processor may be configured to generate multiple optimized configuration commands based at least in part upon the possible modifications and perform additional communication operations in accordance with the optimized configuration commands in response to generating the optimized configuration commands.

### TECHNICAL FIELD

The present disclosure relates generally to optimization of communication operations in a communication system, and more specifically to analyzing communication operations in a simulated environment.

### BACKGROUND

In some wireless communications systems, physical elements in an environment may impact reception and/or transmission of communication signals. For example, foliage of trees adjacent to a reception terminal may cause quality of service to be dropped at the reception terminal. From the perspective of an operator managing communication operations at the reception terminal, it may be difficult to identify causes associated with drops in the quality of service. Further, a location of the reception terminal may add difficulties to determining any physical elements acting as obstacles in the environment.

### SUMMARY OF THE DISCLOSURE

In one or more embodiments, system and methods disclosed herein are configured to analyze one or more communication operations in a simulated (e.g., virtual) environment. The communication operations may be simulated as being performed by an apparatus configured as a communication terminal (e.g., a base station). The simulated environment may be generated in accordance with one or more simulation parameters, operational information describing expected operations of the apparatus, and/or physical information defining a position of the apparatus on Earth. In the simulated environment, one or more artificial intelligence (AI) commands may be configured along with a machine learning (ML) algorithm to dynamically predict operational changes and/or physical changes to the apparatus and/or surrounding areas of the apparatus over a period of time. Further, the AI commands and the ML algorithm may be configured to generate simulated communication operations of the apparatus over the period of time based on the predicted operational changes, the predicted physical changes, and/or one or more simulation parameters configured to guide simulations.

In some embodiments, the systems and methods may be configured to analyze the simulated communication operations in view of an expected performance of the apparatus over the period of time. For example, the simulated communication operations may indicate a simulated coverage area for the apparatus over the period of time based on predicted operational changes and physical changes. The system and methods may be configured to evaluate whether the simulated coverage area (e.g., a simulated performance) matches an expected coverage area (e.g., an expected performance). In this regard, the systems and methods may be configured to generate multiple possible modifications based on the analysis of the simulated communication operations and one or more results of the comparison (e.g., the expected performance is equal, less than, or greater than the simulated performance). The possible modifications may be suggestions to modify operational or physical aspects of the apparatus. For example, the possible modifications may be suggestions to prevent drops in quality of service at the apparatus over the period of time. In some embodiments, multiple optimized configuration commands may be generated based on the one or more possible modifications. The optimized configuration commands may be one or more updates to existing configuration commands that control operations in the apparatus. For example, the optimized configuration commands are configured to implement and/or report the one or more possible modifications and/or modify the apparatus to avoid, prevent, and/or eliminate the drops of the quality of service over the period of time.

In one or more embodiments, the systems and methods described herein are integrated into a practical application to analyze communication operations of an apparatus in a simulated environment. In particular, the systems and methods are integrated into a practical application of dynamically generating possible modifications to existing configuration commands based on analyses of simulated communication operations in the simulated environment. For example, the systems and methods may analyze changes of simulated communication operations for the apparatus in the simulated environment over a period of time. The changes may be dynamically generated based on predicted operational changes and/or physical changes to the apparatus and/or surroundings of the apparatus. The systems and methods may train an ML algorithm with the predicted changes. In a future event, based at least in part on the training, the systems and methods may implement the ML algorithm to preemptively generate possible modifications to one or more configuration commands of the apparatus.

In addition, the systems and methods described herein are integrated into a technical advantage of increasing processing speeds in a computer system, because processors associated with the systems and methods comprise the ML algorithm that actively generates insights for any possible communication operations to be performed by an apparatus over a period of time. In the ML algorithm, the systems and methods may provide the optimized configuration commands based on some or all raw data obtained from the simulated performance. As the ML algorithm is trained to account for many of the situations and conditions occurring in/at the apparatus, multiple optimized configuration commands are generated to relieve stress conditions in communication networks during the communication operations of the apparatus over the period of time. As a result, processing speed during communication operations is improved because the systems and methods comprise optimized configuration commands that may preventively set conditions during the communication operations to prevent stress in the networks and reduce traffic. Under these improvements, the systems and methods provide a practical application of maintaining operations in the network for longer periods of time by reducing downtime caused by heavy traffic conditions in the networks.

In one or more embodiments, the system and the method may be performed by an apparatus, such as a server, communicatively coupled to multiple network components in a core network, one or more base stations in a radio access network, and one or more user equipment. Further, the system may be a wireless communication system, which comprises the apparatus. In addition, the system and the method may be performed as part of a process performed by the apparatus communicatively coupled to the network components in the core network. As a non-limiting example, the apparatus may comprise a memory and a processor communicatively coupled to one another. The memory may be configured to store a machine learning algorithm configured to analyze and structure information associated with one or more communication operations performed by the apparatus and multiple existing configuration commands configured to enable execution of the one or more communication operations. The processor may be configured to perform multiple communication operations in accordance with the existing configuration commands and determine simulation parameters based at least in part upon the communication operations. The simulation parameters may be representative of a simulated performance of the apparatus in a simulated environment. Further, the processor is configured to generate a simulated performance of the apparatus over a period of time in the simulated environment in response to executing the machine learning algorithm, compare the simulated performance to an expected performance of the apparatus, determine whether the simulated performance matches the expected performance, and determine multiple possible modifications to the existing configuration commands in response to determining that the simulated performance does not match the expected performance. The possible modifications may comprise possible updates to the existing configuration commands. The processor may be configured to generate multiple optimized configuration commands based at least in part upon the possible modifications and perform additional communication operations in accordance with the optimized configuration commands in response to generating the optimized configuration commands.

Certain embodiments of this disclosure may comprise some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example communication system in accordance with one or more embodiments;

FIG. 2 illustrates examples of one or more simulation operations performed in conjunction with the example communication system of FIG. 1; and

FIG. 3 illustrates an example flowchart of a method to analyze communication operations in a simulated environment in conjunction with the operational flow of FIG. 2.

### DETAILED DESCRIPTION

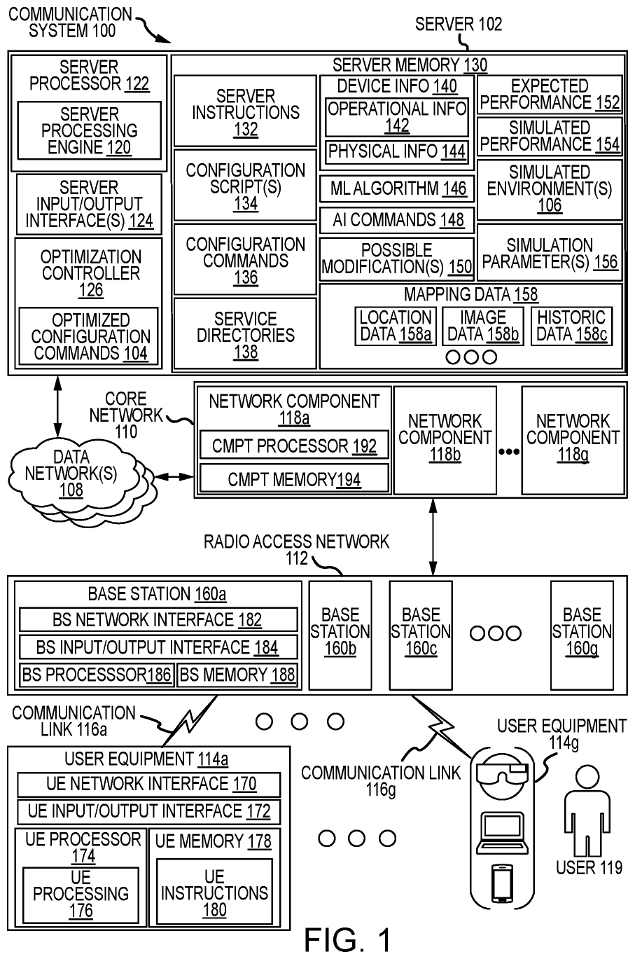

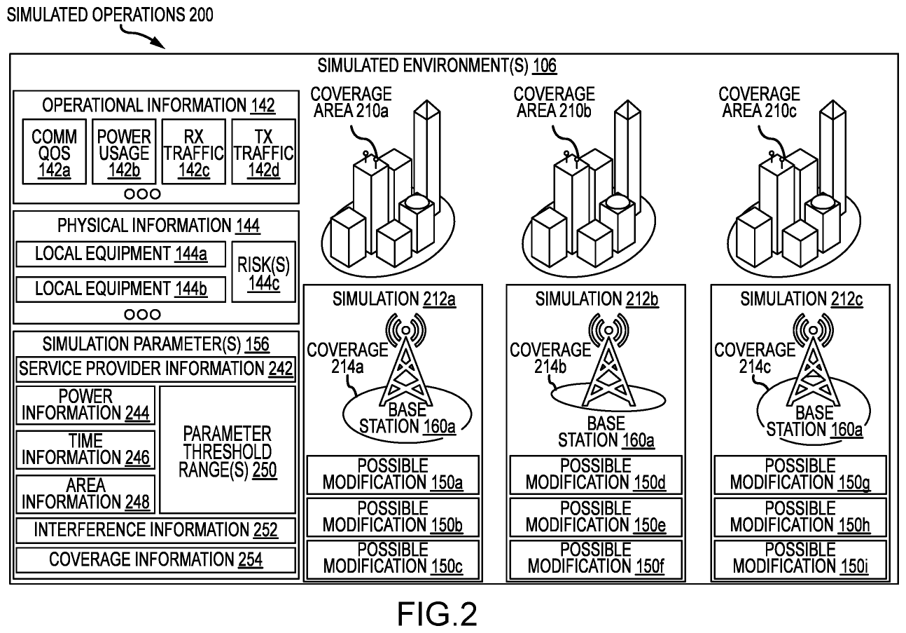

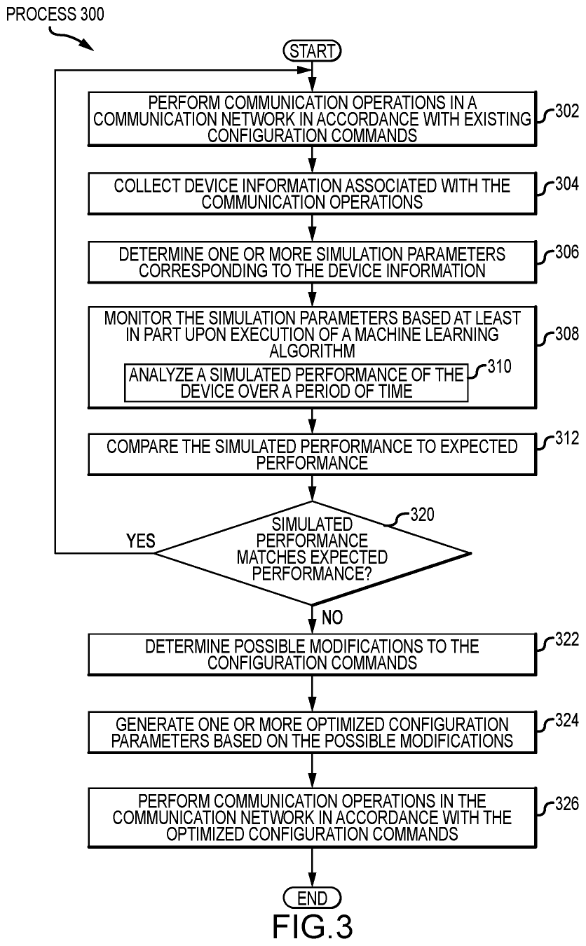

In one or more embodiments, this disclosure provides various systems and methods to analyze communication operations in a simulated (e.g., virtual) environment. FIG. 1 illustrates a communication system 100 in which a server 102 generates one or more optimized configuration commands 104 based at least in part upon one or more analysis operations performed in one or more simulated environments 106. FIG. 2 illustrates simulation operations 200 performed by the communication system 100 of FIG. 1. FIG. 3 illustrates a process 300 performed by the communication system 100 of FIG. 1.

### Communication System Overview

FIG. 1 illustrates a diagram of a communication system 100 (e.g., a wireless communication system) that comprises a server 102 configured to generate optimized configuration commands 104 for one or more operations to be performed by an apparatus acting as a communication terminal, in accordance with one or more embodiments. In the communication system 100 of FIG. 1, the server 102 may be the communication terminal communicatively coupled to one or more data networks 108, a core network 110, and a radio access network (RAN) 112. In FIG. 1, the server 102 is communicatively coupled to multiple user equipment 114a-114g (collectively, user equipment 114) via the RAN 112 via multiple corresponding communication links 116a-116g (collectively, communication links 116) established between each user equipment 114 and the RAN 112. As represented by a user equipment 114a, the user equipment 114 may be operated or attended to by one or more users 119. In the example of FIG. 1, the server 102 may be communicatively coupled to multiple additional devices in the communication system 100. While FIG. 1 shows the server 102 connected directly to the one or more data networks 108, the server 102 may be located inside the core network 110 as part of one or more of the network components (e.g., any of the network components 118a-118g) in the core network 110.

In one or more embodiments, the communication system 100 comprises the user equipment 114, the RAN 112, the core network 110, the one or more data networks 108, and the server 102. In come embodiments, the communication system 100 may comprise a Fifth Generation (5G) mobile network or wireless communication system, utilizing high frequency bands (e.g., 24 Gigahertz (GHz), 39 GHz, and the like) or lower frequency bands such (e.g., Sub 6 GHZ). In this regard, the communication system 100 may comprise a large number of antennas. In some embodiments, the communication system may perform one or more operations associated with the 5G New Radio (NR) protocols described in reference to the Third Generation Partnership Project (3GPP). As part of the 5G NR protocols, the communication system 100 may perform one or more millimeter (mm) wave technology operations to improve bandwidth or latency in wireless communications.

In some embodiments, the communication system 100 may be configured to partially or completely enable communications via one or more various radio access technologies (RATs), wireless communication technologies, or telecommunication standards, such as Global System for Mobiles (GSM) (e.g., Second Generation (2G) mobile networks), Universal Mobile Telecommunications System (UMTS) (e.g., Third Generation (3G) mobile networks), Long Term Evolution (LTE) of mobile networks, LTE-Advanced (LTE-A) mobile networks, 5G NR mobile networks, or Sixth Generation (6G) mobile networks.

### Communication System Components

### Server

The server 102 is generally any device or apparatus that is configured to process data, communicate with the data networks 108, one or more network components 118a-118g (collectively, network components 118) in the core network 110, the RAN 112, and the user equipment 114. The server 102 may be configured to monitor, track data, control routing of signal, and control operations of certain electronic components in the communication system 100, associated databases, associated systems, and the like, via one or more interfaces. The server 102 is generally configured to oversee operations of the server processing engine 120. The operations of the server processing engine 120 are described further below. In some embodiments, the server 102 comprises a server processor 122, one or more server Input (I)/Output (O) interfaces 124, an optimization controller 126 configured to generate one or more optimized configuration commands 104, and a server memory 130 communicatively coupled to one another. The server 102 may be configured as shown, or in any other configuration. As described above, the server 102 may be located in one of the network components 118 located in the core network 110 and may be configured to perform one or more network functions (NFs) associated with simulation operations 200 described in reference to FIG. 2.

The server processor 122 may comprise one or more processors operably coupled to and in signal communication with the one or more server I/O interfaces 124, the optimization controller 126, and the server memory 130. The server processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 122 may be a programmable logic device, a microcontroller, a microprocessor, or any suitable combination of the preceding. The one or more processors in the server processor 122 are configured to process data and may be implemented in hardware or software executed by hardware. For example, the server processor 122 may be an 8-bit, a 16-bit, a 32-bit, a 64-bit, or any other suitable architecture. The server processor 122 may comprise an arithmetic logic unit (ALU) to perform arithmetic and logic operations, processor registers that supply operands to the ALU, and store the results of ALU operations, and a control unit that fetches software instructions such as server instructions 132 from the server memory 130 and executes the server instructions 132 by directing the coordinated operations of the ALU, registers and other components via the server processing engine 120. The server processor 122 may be configured to execute various instructions. For example, the server processor 122 may be configured to execute the server instructions 132 to perform functions or perform operations disclosed herein, such as some or all of those described with respect to FIGS. 1-3. In some embodiments, the functions described herein are implemented using logic units, FPGAs, ASICs, DSPs, or any other suitable hardware or electronic circuitry.

In one or more embodiments, the server I/O interfaces 124 may be hardware configured to perform one or more simulation operations 200 described in reference to FIG. 2. The server I/O interfaces 124 may comprise one or more antennas as part of a transceiver, a receiver, or a transmitter for communicating using one or more wireless communication protocols or technologies. In some embodiments, the server I/O interfaces 124 may be configured to communicate using, for example, NR or LTE using at least some shared radio components. In other embodiments, the server I/O interfaces 124 may be configured to communicate using single or shared radio frequency (RF) bands. The RF bands may be coupled to a single antenna, or may be coupled to multiple antennas (e.g., for a multiple-input multiple output (MIMO) configuration) to perform wireless communications. The server I/O interfaces 124 may be configured to comprise one or more peripherals such as a network interface, one or more administrator interfaces, and one or more displays.

The server network interfaces that may be part of the server I/O interfaces 124 may be any suitable hardware or software (e.g., executed by hardware) to facilitate any suitable type of communication in wireless or wired connections. These connections may comprise, but not be limited to, all or a portion of network connections coupled to additional network components 118 in the core network 110, the RAN 112, the user equipment 114, the Internet, an Intranet, a private network, a public network, a peer-to-peer network, the public switched telephone network, a cellular network, a local area network (LAN), a metropolitan area network (MAN), a wide area network (WAN), and a satellite network. The server network interface may be configured to support any suitable type of communication protocol.

The one or more administrator interfaces that may be part of the server I/O interfaces 124 may be user interfaces configured to provide access and control to of the server 102 to one or more users (e.g., the user 119) or electronic devices. The one or more users may access the server memory 130 upon confirming one or more access credentials to demonstrate that access or control to the server 102 may be modified. In some embodiments, the one or more administrator interfaces may be configured to provide hardware and software resources to the one or more users. Examples of user devices comprise, but are not limited to, a laptop, a computer, a smartphone, a tablet, a smart device, an Internet-of-Things (IoT) device, a simulated reality device, an augmented reality device, or any other suitable type of device. The administrator interfaces may enable access to one or more graphical user interfaces (GUIs) via an image generator display (e.g., one or more displays), a touchscreen, a touchpad, multiple keys, multiple buttons, a mouse, or any other suitable type of hardware that allow users to view data or to provide inputs into the server 102. The server 102 may be configured to allow users to send requests to one or more user equipment 114.

In the example of FIG. 1, the one or more displays that may be part of the server I/O interfaces 124 may be configured to display a two-dimensional (2D) or three-dimensional (3D) representation of a service. Examples of the representations may comprise, but are not limited to, a graphical or simulated representation of an application, diagram, tables, or any other suitable type of data information or representation. In some embodiments, the one or more displays may be configured to present visual information to one or more users (not shown). The one or more displays may be configured to present visual information to the one or more users updated in real-time. The one or more displays may be a wearable optical display (e.g., glasses or a head-mounted display (HMD)) configured to reflect projected images and enable user to see through the one or more displays. For example, the one or more displays may comprise display units, one or more lenses, one or more semi-transparent mirrors embedded in an eye glass structure, a visor structure, or a helmet structure. Examples of display units comprise, but are not limited to, a cathode ray tube (CRT) display, a liquid crystal display (LCD), a liquid crystal on silicon (LCOS) display, a light emitting diode (LED) display, an organic LED (OLED) display, an active-matrix OLED (AMOLED) display, a projector display, or any other suitable type of display. In another embodiment, the one or more displays are a graphical display on the server 102. For example, the graphical display may be a tablet display or a smartphone display configured to display the data representations.

In some embodiments, the optimization controller 126 may be any combination of a baseband processor, analog RF signal processing circuitry (e.g., including filters, mixers, oscillators, amplifiers, and the like), or digital processing circuitry (e.g., for digital modulation as well as other digital processing). For example, the optimization controller 126 may be configured to allocate power, frequency, and sensing resources during wireless simulation operations 200 described in reference to FIG. 2. In some embodiments, the optimization controller 126 may be configured to generate one or more of optimized configuration commands 104.

The server memory 130 may be volatile or non-volatile and may comprise a read-only memory (ROM), random-access memory (RAM), ternary content-addressable memory (TCAM), dynamic random-access memory (DRAM), and static random-access memory (SRAM). The server memory 130 may be implemented using one or more disks, tape drives, solid-state drives, and/or the like. The server memory 130 is operable to store the server instructions 132, one or more configuration scripts 134, one or more existing configuration commands 136, one or more service directories 138, device information 140 comprising operational information 142 and physical information 144, a machine learning algorithm 146, multiple artificial intelligence commands 148, one or more possible modifications 150, an expected performance 152, simulated performance 154, the one or more simulated environments 106, one or more simulation parameters 156, and/or one or more mapping data 158 comprising multiple data types 158a-158c. In the server memory 130, the server instructions 132 may comprise commands and controls for operating one or more specific NFs in the core network 110 when executed by the server processing engine 120 of the server processor 122.

In one or more embodiments, the one or more configuration scripts 134 are configured to instruct one or more network components 118 in the core network 110 to establish one or more configuration commands 136 or one of the optimized configuration commands 104 to perform the operations. The one or more configuration scripts 134 enable automation of the routing and configuration of network components 118 in the core network 110. In this regard, the one or more configuration scripts 134 may reconfigure multiple cloud-NFs (CNFs) that establish initial communication sessions with at least one NRF in a communication path comprising one or more additional network components 118. In this regard, the one or more configuration scripts 134 instruct routing and configuration of communication procedures based on static routing commands to restore restores services in the core network 110.

In one or more embodiments, the configuration commands 136 are configured to establish one or more communication sessions between the network components 118 in the core network 110 and the user equipment 114. Each configuration command of the configuration commands 136 may be configured to provide control information to perform one or more of the operations. Further, the configuration commands 136 may be routing and configuration information for reinstating or reestablishing communication sessions. The configuration commands 136 may be dynamically or periodically updated from the network components 118 in the core network 110. In one or more embodiments, the optimized configuration commands 104 are configured to establish one or more optimized communication sessions between the network components 118 in the core network 110 and the user equipment 114. Each configuration command of the optimized configuration commands 104 may be configured to provide control information to perform one or more of the operations based at least in part upon the analyzed data from the simulated environments 106. Further, the optimized configuration commands 104 may be routing and configuration information for reinstating or reestablishing communication sessions. The optimized configuration commands 104 may be dynamically or periodically updated based on analysis of the one or more simulated environments 106. In some embodiments, the optimized configuration commands 104 may comprise possible updates to the existing configuration commands 136.

The service directories 138 may be configured to store service-specific information and/or user-specific information. The service directories 138 may enable the server 102 to confirm user credentials to access one or more network components (e.g., one of the network components 118 configured to perform one or more NFs in the core network 110. The service directories 138 may be configured to store provider-specific information. The service directories 138 may enable the server 102 to validate credentials associated with a specific provider (e.g., one of the CNFs) against corresponding user-specific information in the service directories 138.

The device information 140 may be information associated with the server 102. Herein, the device information 140 comprises operational information 142 and physical information 144 among other types of information. The operational information 142 may be information indicating one or more operations performed by the server in the communication system 100. For example, the operational information 142 may comprise indicators of one or more routing preferences for communication channels controlled by the server 102. The physical information 144 may be information indicative of physical measurements of the server 102 and/or surrounding areas of the server 102 on Earth. For example, the physical information 144 may comprise one or more physical details of the server 102. The physical details may comprise information on one or more antennas (e.g., height, width, power output, and the like) attached to the server 102, the infrastructure associated with the server 102 (e.g., height and/or materials of the infrastructure comprising the server 102), and the weather surrounding the server 102 over the period of time among others.

In some embodiments, the device information 140 is predefined information received by the server 102 during a maintenance window. In other embodiments, the device information 140 is dynamically modified information that is received by the server 102 outside of a maintenance window. In one or more embodiments, the server may receive and/or update the device information 140 statically (e.g., predefined) and/or dynamically over time. In some embodiments, the device information 140 may be updated in accordance with rules and policies of an organization.

In one or more embodiments, the machine learning algorithm 146 may be configured to converts the data stored by the simulated environments 106 to generate structured data for further analysis. Further, the machine learning algorithm 146 may be configured to interpret and analyze the device information 140 and the simulation parameters 156 into structured data sets and subsequently stored as files or tables. The machine learning algorithm 146 may cleanse, normalize raw data, and derive intermediate data to generate uniform data in terms of encoding, format, and data types. The machine learning algorithm 146 may be executed to run user queries and advanced analytical tools on the structured data. The machine learning algorithm 146 may be configured to generate the one or more artificial intelligence commands 148 based on current communication operations and the existing configuration commands 136. In turn, the optimization controller 126 may be configured to generate the optimized configuration commands 104 based on the outputs of the machine learning algorithm 146. The artificial intelligence commands 148 may be parameters that modify routing of resources in the configuration scripts 134 to be allocated in the communication network. The artificial intelligence commands 148 may be combined with the existing configuration commands 136 to create the optimized configuration commands 104.

In some embodiments, the machine learning algorithm 146 may be configured to generate the one or more artificial intelligence commands 148 based on the existing configuration commands 136. In turn, the server processor 122 may be configured to generate the possible modifications 150 and the simulated performance 154 based on one or more outputs of the machine learning algorithm 146. The artificial intelligence commands 148 may be parameters that modify the possible modifications 150 and the simulated performance 154. The artificial intelligence commands 148 may be combined with the existing configuration commands 136 to create the possible modifications 150 and the simulated performance 154. In one or more embodiments, the possible modifications 150 may be dynamically generated updates for the existing configuration commands 136.

The possible modifications 150 may be recommendations presented to the network components 118, the base stations 160, and/or the user equipment 114 based on the expected performance 152 and the simulated performance 154. The possible modifications 150 may comprise one or more dynamic suggestions to modify the one or more configuration commands 136. In one or more embodiments, the dynamic suggestions are the one or more optimized configuration commands 104 configured to control operations of the server 102 and/or the simulated environments 106. The optimized configuration commands 104 may be configured to dynamically provide control information to perform one or more of the operations based at least in part upon the analyzed device information 140, the simulation parameters 156, and the mapping data 158 in the simulated environments 106.

In one or more embodiments, the simulated performance 152 may comprise possible impacts to the server 102 over the period of time. The simulated performance 152 may be a simulated change of the device information 140 over the period of time. The possible impacts may be interruptions caused to the communication operations performed by the server 102. In some embodiments, the optimized configuration commands 104 may be generated to indicate one or more instructions 132 to incorporate the one or more possible modifications 150 into future communication operations the server 102.

In one or more embodiments, the simulated environments 106 may be a sandbox environment in which communication operations may be simulated for the server 102 over a period of time. In the sandbox environment, the server 102 may simulate communication operations while monitoring whether the representative version of the server 102 performs as expected. If the representative version of the server 102 does not perform as expected, the server 102 may be configured to generate possible fixes to the simulated performance 154 and test those fixes on a new version of the representative version of the server 102. After determining fixes that allow the new version of the representative a version of the server 102 to perform as expected, the server 102 may generate one or more optimized configuration commands 104 with instructions on how to implement the fixes in the original application. The representative version of the server 102 may be deleted after the optimized configuration commands 104 are generated.

The mapping data 158 may be one or more data types comprising location data 158a, image data 158b, and historic data 158c among other types of data. The location data 158a may comprise location information indicating positioning information of the server 102 in Earth. The image data 158b may be multiple images comprising a visual representation of the position of the server 102 on Earth. The historic data 158c may comprise information indicating changes and/or modifications to the mapping data 158 over time. In some embodiments, the mapping data 158 may comprise satellite imaging, infrared imaging, and/or topographical information among others. The mapping data 158 may be two-dimensional (2D) and/or three-dimensional (3D).

In some embodiments, the simulated environments 106 may be radio frequency simulation using a digital representation of the apparatus and surroundings of the apparatus (e.g., a digital twin). The server 102 may be configured to evaluate the mapping data 158 (e.g., high-resolution images and terrain information) and input the mapping data 158 to generate one or more of the simulation environments 106 to simulate and optimize radio frequency performance. For example, the machine learning algorithm 146 and the artificial intelligence commands 148 may be configured to predict foliage growth and building construction based on the mapping data 158 to predict future interference. In this regard, the simulation environments 106 may be configured to allow the digital twin to predict future interference (e.g., photos taken in winter may be aged to account for leaf growth where fast growing trees are identified nearby) over a period of time (e.g., days, weeks, months, or years to optimize network performance over time.

In one or more embodiments, as a non-limiting example, the server 102 may be comprised in one or more of the network components 118, one or more of the base stations 160, and/or one or more of the user equipment 114. In some embodiments, the server 102 may be configured to generate the one or more simulated environments 106 based on the device information 140, the simulated parameters 156, and/or the mapping data 158.

### User Equipment

In one or more embodiments, each of the user equipment 114 (e.g., the user equipment 114a and a user equipment 114g representative of the user equipment 114a-114g) may be any computing device configured to communicate with other devices, such as the server 102, other network components 118 in the core network 110, databases, and the like in the communication system 100. Each of the user equipment 114 may be configured to perform specific functions described herein and interact with one or more network components 118 in the core network 110 via one or more base stations 160. Examples of user equipment 114 comprise, but are not limited to, a laptop, a computer, a smartphone, a tablet, a smart device, an IoT device, a simulated reality device, an augmented reality device, or any other suitable type of device.

In one or more embodiments, referring to the user equipment 114a as a non-limiting example of the user equipment 114, the user equipment 114a may comprise a user equipment (UE) network interface 170, a UE I/O interface 172, a UE processor 174 configured to execute a UE processing engine 176, and a UE memory 178 comprising one or more UE instructions 180. The UE network interface 170 may be any suitable hardware or software (e.g., executed by hardware) to facilitate any suitable type of communication in wireless or wired connections. These connections may comprise, but not be limited to, all or a portion of network connections coupled to additional network components 118 in the core network 110, the RAN 112, the Internet, an Intranet, a private network, a public network, a peer-to-peer network, the public switched telephone network, a cellular network, a local area network (LAN), a metropolitan area network (MAN), a wide area network (WAN), and a satellite network. The UE network interface 170 may be configured to support any suitable type of communication protocol.

The UE I/O interface 172 may be hardware configured to perform one or more simulation operations 200 described in reference to FIGS. 2 and 3. The UE I/O interface 172 may comprise one or more antennas as part of a transceiver, a receiver, or a transmitter for communicating using one or more wireless communication protocols or technologies. In some embodiments, the UE I/O interface 172 may be configured to communicate using, for example, 5G NR or LTE using at least some shared radio components. In other embodiments, the UE I/O interface 172 may be configured to communicate using single or shared RF bands. The RF bands may be coupled to a single antenna, or may be coupled to multiple antennas (e.g., for a MIMO configuration) to perform wireless communications. In some embodiments, the user equipment 114a may comprise capabilities for voice communication, mobile broadband services (e.g., video streaming, navigation, and the like), or other types of applications. In this regard, the UE I/O interface 172 of the user equipment 114a may communicate using machine-to-machine (M2M) communication, such as machine-type communication (MTC), or another type of M2M communication.

In some embodiments, the user equipment 114a is communicatively coupled to one or more of the base stations 160 via one or more communication links 116 (e.g., the communication link 116a and the communication link 116g representative of the communication links 116). The user equipment 114a may be a device with cellular communication capability such as a mobile phone, a hand-held device, a computer, a laptop, a tablet, a smart watch or other wearable device, or virtually any type of wireless device. In some applications, the user equipment 114 may be referred to as a UE, UE device, or terminal.

The UE processor 174 may comprise one or more processors operably coupled to and in signal communication with the UE network interface 170, the UE I/O interface 172, and the UE memory 178. The UE processor 174 is any electronic circuitry, including, but not limited to, state machines, one or more CPU chips, logic units, cores (e.g., a multi-core processor), FPGAs, ASICs, or DSPs. The UE processor 174 may be a programmable logic device, a microcontroller, a microprocessor, or any suitable combination of the preceding. The one or more processors in the UE processor 174 are configured to process data and may be implemented in hardware or software executed by hardware. For example, the UE processor 174 may be an 8-bit, a 16-bit, a 32-bit, a 64-bit, or any other suitable architecture. The UE processor 174 comprises an ALU to perform arithmetic and logic operations, processor registers that supply operands to the ALU, and store the results of ALU operations, and a control unit that fetches software instructions such as the UE instructions 180 from the UE memory 178 and executes the UE instructions 180 by directing the coordinated operations of the ALU, registers, and other components via the UE processing engine 176. The UE processor 174 may be configured to execute various instructions. For example, the UE processor 174 may be configured to execute the UE instructions 180 to implement functions or perform operations disclosed herein, such as some or all of those described with respect to FIGS. 1-3. In some embodiments, the functions described herein are implemented using logic units, FPGAs, ASICs, DSPs, or any other suitable hardware or electronic circuitry.

### Radio Access Network

In one or more embodiments, the RAN 112 enables the user equipment 114 to access one or more services in the core network 110. The one or more services may be a mobile telephone service, a Short Message Service (SMS) message service, a Multimedia Message Service (MMS) message service, an Internet access, cloud computing, or other types of data services. The RAN 112 may comprise the base stations 160 in signal communication with the user equipment 114 via the one or more communication links 116. Each of the base stations 160 may service the user equipment 114. In some embodiments, while multiple base stations 160 are shown connected to multiple user equipment 114 via the communication link 116, one or more additional base stations 160 may be connected to one or more additional user equipment 114 via one or more additional communication links 116. For example, the base station 160a-110g may exchange connectivity signals with the user equipment 114a via the communication link 116a. In another example, the base station 160G may exchange connectivity signals with the user equipment 114g via the communication link 116g. In yet another example, the base stations 160 may service some user equipment 114 located within a geographic area serviced by one of the base

In one or more embodiments, referring to the base station 160a as a non-limiting example of the base station 160, the base station 160a may comprise a base station (BS) network interface 182, a BS I/O interface 184, a BS processor 186, and a BS memory 188. The BS network interface 182 may be any suitable hardware or software (e.g., executed by hardware) to facilitate any suitable type of communication in wireless or wired connections between the core network 110 and the user equipment 114. These connections may comprise, but not be limited to, all or a portion of network connections coupled to additional network components 118 in the core network 110, other base stations 160, the user equipment 114, the Internet, an Intranet, a private network, a public network, a peer-to-peer network, the public switched telephone network, a cellular network, a LAN, a MAN, a WAN, and a satellite network. The BS network interface 182 may be configured to support any suitable type of communication protocol.

The BS I/O interface 184 may be hardware configured to perform one or more simulation operations 200 described in reference to FIG. 2. The BS I/O interface 184 may comprise one or more antennas as part of a transceiver, a receiver, or a transmitter for communicating using one or more wireless communication protocols or technologies. In some embodiments, the BS I/O interface 184 may be configured to communicate using, for example, 5G NR or LTE using at least some shared radio components. In other embodiments, the BS I/O interface 184 may be configured to communicate using single or shared RF bands. The RF bands may be coupled to a single antenna, or may be coupled to multiple antennas (e.g., for a MIMO configuration) to perform wireless communications. In some embodiments, the base station 160A may allocate resources in accordance with one or more routing and configuration operations obtained from the core network 110. In some embodiments, resources may be allocated to enable capabilities in the user equipment 114 for voice communication, mobile broadband services (e.g., video streaming, navigation, and the like), or other types of applications.

In some embodiments, the base station 160A is communicatively coupled to one or more of the user equipment 114 via the one or more communication links 116. In some applications, the base stations 160a may be referred to as BS, evolved Node B (eNodeB or eNB), a next generation Node B, gNodeB, gNB, or terminal.

The BS processor 186 may comprise one or more processors operably coupled to and in signal communication with the BS network interface 182, the BS I/O interface 184, and the BS memory 188. The BS processor 186 is any electronic circuitry, including, but not limited to, state machines, one or more CPU chips, logic units, cores (e.g., a multi-core processor), FPGAs, ASICs, or DSPs. The BS processor 186 may be a programmable logic device, a microcontroller, a microprocessor, or any suitable combination of the preceding. The one or more processors in the BS processor 186 are configured to process data and may be implemented in hardware or software executed by hardware. For example, the BS processor 186 may be an 8-bit, a 16-bit, a 32-bit, a 64-bit, or any other suitable architecture. The BS processor 186 comprises an ALU to perform arithmetic and logic operations, processor registers that supply operands to the ALU, and store the results of ALU operations, and a control unit that fetches software instructions (not shown) from the BS memory 188 and executes the software instructions by directing the coordinated operations of the ALU, registers, and other components via a processing engine (not shown) in the BS processor 186. The BS processor 186 may be configured to execute various instructions. For example, the BS processor 186 may be configured to execute the software instructions to implement functions or perform operations disclosed herein, such as some or all of those described with respect to FIGS. 1-3. In some embodiments, the functions described herein are implemented using logic units, FPGAs, ASICs, DSPs, or any other suitable hardware or electronic circuitry.

### Core Network

The core network 110 may be a network configured to manage communication sessions for the user equipment 114. In one or more embodiments, the core network 110 may establish connections between user equipment 114 and a particular data network 108 in accordance with one or more communication protocols. In the example of FIG. 1, the core network 110 comprises one or more network components configured to perform one or more NFs. In some embodiments, the core network 110 enables the user equipment 114 to communicate with the server 102, or another type of device, located in a particular data network 108 or in signal communication with a particular data network 108. The core network 110 may implement a communication method that does not require the establishment of a specific communication protocol connection between the user equipment 114 and one or more of the data networks 108. The core network 110 may include one or more types of network devices (not shown), which may perform different NFs.

In some embodiments, the core network 110 may include a 5G NR or an LTE access network (e.g., an evolved packet core (EPC) network) among others. In this regards, the core network 110 may comprise one or more logical networks implemented via wireless connections or wired connections. Each logical network may comprise an end-to-end virtual network with dedicated power, storage, or computation resources. Each logical network may be configured to perform a specific application comprising individual policies, rules, or priorities. Further, each logical network may be associated with a particular Quality of Service (QOS) class, type of service, or particular user associated with one or more of the user equipment 114. For example, a logical network may be a Mobile Private Network (MPN) configured for a particular organization. In this example, when the user equipment 114a is configured and activated by a wireless network associated with the RAN 112, the user equipment 114a may be configured to connect to one or more particular network slices (i.e., logical networks) in the core network 110. Any logical networks or slices that may be configured for the user equipment 114a may be configured using a network component (e.g., one of the network components 118 (e.g., the network component 118a, the network component 118b, and the network component 118g representing the network component 118a-118g) of FIG. 1.

In one or more embodiments, each of the network components 118 may comprise a component processor 192 configured to perform one or more similar operations to those described in reference to the BS processor 186 and the UE processor 174. In other embodiments, each of the network components 118 may comprise a component memory 194 configured to perform one or more similar operations to those described in reference to the BS memory 188 and the UE memory 178.

### Data Networks

In the example system 100 of FIG. 1, the data networks 108 may facilitate communication within the communication system 100. This disclosure contemplates that the data networks 108 may be any suitable network operable to facilitate communication between the server 102, the core network 110, the RAN 112, and the user equipment 114. The data networks 108 may include any interconnecting system capable of transmitting audio, video, signals, data, messages, or any combination of the preceding. The data networks 108 may include all or a portion of a LAN, a WAN, an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, and the like), a Long Term Evolution (LTE) network, a Universal Mobile Telecommunications System (UMTS) network, a peer-to-peer (P2P) network, a Bluetooth network, a Near Field Communication network, a Zigbee network, or any other suitable network, operable to facilitate communication between the components of the communication system 100. In other embodiments, the communication system 100 may not have all of these components or may comprise other elements instead of, or in addition to, those above.

### Simulation Operations

FIG. 2 illustrates one or more simulation operations 200 in accordance with one or more embodiments. The simulation operations 200 may be performed by the server 102. In the non-limiting example of FIG. 2, the server 102 may be configured to generate and analyze communication operations of a base station 160a in the one or more simulated environments 106. The simulated environments 106 may be configured to be stored in the server memory 130. The simulated environments 106 may comprise simulated representation of the base station 160a at a location remote to the server 102. In the example of FIG. 2, the server 102 may be configured to generate and analyze a simulated performance 152 of the base station 160a in the simulated environments 106. The simulated environments 106 may comprise audio and/or visual representation of the communication operations of the base station 160a over a period of time. The simulation operations 200 shown multiple coverage area 210a-210c (collectively, coverage area 210) to be analyzed based on the operational information 142, the physical information 144, and the one or more simulation parameters 156 over a period of time. The simulated environments 106 may comprise multiple simulations 212a-212c (collectively, simulations 212) showing corresponding simulated coverage areas 214a-214c and possible modifications 150a-150i over the period of time. As described above, the period of time may comprise days, months, and/or years. In some embodiments, the period of time may comprise a year-goal. For example, the simulation environment 106 may be representative of a simulated performance 152 of the base station 160a on a given year. The simulations 212 may be presented in a display and/or an immersive environment (e.g., in virtual reality).

In one or more embodiments, the operational information 142 comprises one or more information elements associated with operation of the base station 160a at a time of initiating the one or more simulations 212. In the example of FIG. 2, the operational information 142 comprises detailed and/or summarized information for communication quality of service (QOS) 142a, power usage 142b, reception (RX) traffic 142c, and transmission (TX) traffic 142d of the base station 160a among others. The operational information 142 may comprise less or more information than those shown in FIG. 2.

In one or more embodiments, the physical information 144 comprises one or more information elements associated with physical aspects of the base station 160a at a time of initiating the one or more simulations 212. In the example of FIG. 2, the physical information 144 comprises detailed and/or summarized information for local equipment information 144a, remote equipment 144b, and risk information 144c among others. The local equipment information 144a may comprise physical details of equipment located locally at the base station 160a. For example, the local equipment information 144a may comprise information for equipment operated to generate power (e.g., batteries), receive and/or transmit signals (e.g., antennas), and/or infrastructure equipment such as lights surrounding the physical area around the base station 160a among others. The remote equipment 144b may comprise physical details of equipment located remote to the base station 160a. For example, the remote equipment 144b may comprise information for equipment operated to deliver power to the base station 160a (e.g., specifications on the power sub-station that delivers power to the base station 160a), other base stations 160 neighboring the base station 160a, and infrastructure used to access the base station 160a (e.g., roads) among others. The risk information 144c may comprise information associated with one or more risks to the base station 160a. For example, the risk information 144c may comprise an indicator that there is risk of snowstorms in the area surrounding the base station 160a based on weather data. The physical information 142 may comprise less or more information than those shown in FIG. 2. In some embodiments, the physical information 144 comprises any physical and/or dimensional aspects (e.g., width, height, and the like) of devices and/or equipment that may be associated with the base station 160a.

In one or more embodiments, the simulation parameters 156 may comprise one or more parameters set as inputs of the simulations 212. As described above, the server 102 may be configured to generate the simulations 212 in the simulated environments 106 based on the detailed information 140 comprising the operational information 142 and/or the physical information 144 and/or the simulation parameters 156. In FIG. 2, the simulation parameters 156 are shown comprising service provider information 242, power information 244, time information 246, area information 248, one or more parameter threshold ranges 250, interference information 252, and coverage information 254. The service provider information 242 may be information associated to service providers that route one or more communication channels via the base station 160a. The power information 244 may comprise information associated with power requirements associated with the base station 160a. Herein, power requirements may be power guidelines as defined in spec sheets or documents for operation of the local equipment information 144a at the base station 160a. The time information 246 may indicate a duration of the simulation performance 154 and/or a duration of any analyses performed on the simulations 212. The area information 248 may comprise information about immediate and/or neighboring surroundings of the base station 160a. For example, the area information 248 may comprise weather data updated dynamically or periodically. The interference information 252 may comprise dampening indicators representative of the impact of infrastructure and/or vegetation may have in reception and/or transmissions operations at the base station 160a. for example, the interference information may comprise a dampening indicator indicating that foliage at a certain distance from a first antenna of the base station 160a may cause QoS during reception of communication signals to drop by a certain value. The coverage information 254 may comprise information referencing an expected traffic load to be handled by the base station 160a over a period of time. In some embodiments, the simulation parameters 156 are predefined, dynamically modified, and/or periodically updated by the server 102, the network components 118, another base station 160, and/or the user equipment 114

In one or more embodiments, the machine learning algorithm 146 is executed to generate one or more of the simulated environments 106 and one or more of the simulations 212. In some embodiments, the simulated environments 106 may be generated based on operational information 142 and the physical information 144 as modified by the one or more the simulation parameters 156. The simulation parameters 156 may be indicators that cause the machine learning algorithm 146 to modify the operational information 142 and/or the physical information 144 over a duration of at least a portion the simulated performance 154 and the simulations 212.

In one or more embodiments, the simulation 212a comprises a visual representation of a coverage area 214a for the service coverage area 210a to be serviced by the base station 160a and possible modifications 150a-150c. The simulation 212b comprises a visual representation of a coverage area 214b for the service coverage area 210b to be serviced by the base station 160a and possible modifications 150d-150f. The simulation 212c comprises a visual representation of a coverage area 214c for the service coverage area 210c to be serviced by the base station 160a and possible modifications 150g-150h.

In some embodiments, the possible modifications 150a-150i may be specific to their respective simulations 212. Further, the simulation parameters 156 may be different for each of the simulations 212. The coverages 214 may be a representation of simulated performance of the base station 160a over the period of time. For example, the simulation 212a for the coverage area 210a may comprise a time information 246 of three months. In this case, the simulation 212a may indicate a simulated performance 154 of the base station 160a over a period of time equal to three months. In this example, the simulated coverage area 214a may indicate that the base station 160a is simulated to perform as expected over the period of time of three months (e.g., the simulated performance 154 may be equal to an expected performance 152 over the period of time). Herein, the possible modifications 150a-150c may be routine suggestions to service the local equipment information 144a by the end of the period of time for routine inspections. For example, the possible modification 150a may be a recommendation to service the antennas of the base station 160a, the possible modification 150b may be a suggestion to trim foliage over a radius of 20 meters (m) around the base station 160a, and the possible modification 150c may be a suggestion to winterize the base station 160a ahead of a fall season. In some embodiments, the server 102 may generate one or more optimized configuration commands 104 to implement at least a portion of the possible modifications 150a-150c and/or to report the possible modifications 150a-150c.

In turn, the simulation 212b and the simulation 212c may be alternative performances of the base station 160a based at least in part upon one or more changes to the simulation parameters 156. For example, the simulation 212b for the coverage area 210b may comprise a time information 246 of six years. In this case, the simulation 212b may indicate a simulated performance 154 of the base station 160a over a period of time equal to six years. In this example, the simulated coverage area 214b may indicate that the base station 160a is not simulated to perform as expected over the period of time of six years (e.g., the simulated performance 154 may be less than an expected performance 152 over the same period of time). Herein, the possible modifications 150d-150f may be suggestions to modify the operations and/or the infrastructure of the base station 160a. For example, the possible modification 150d may be a recommendation to create a new road to access the base station 160a upon determining that a new bridge is being built near the base station 160a, the possible modification 150e may be a suggestion to replace the antennas of the base station the base station 160a every two years, and the possible modification 150e may be a suggestion to add a one or more additional base stations 160 in the surrounding areas based on identifier population trends for an area and/or region where the base station 160a is located. In some embodiments, the server 102 may generate one or more optimized configuration commands 104 to implement at least a portion of the possible modifications 150d-150f and/or to report the possible modifications 150d-150f.

Further, the simulation 212c for the coverage area 210c may comprise a time information 246 of one week. In this case, the simulation 212c may indicate a simulated performance 154 of the base station 160a over a period of time equal to one week. In this example, the simulated coverage area 214c may indicate that the base station 160a is simulated to perform exceeding the expected performance 152 over the period of time of one week (e.g., the simulated performance 154 may be greater than an expected performance 152 over the same period of time). Herein, the possible modifications 150g-150i may be urgent suggestions to make changes to communication operations at the base station 160a. For example, the possible modification 150g may be a recommendation to increase a traffic load from one or more neighboring base stations 160 while those base stations 160 are power down for maintenance, the possible modification 150g may be a suggestion to increase power delivery to the base station 160a to allow for allocation of additional power resources, and the possible modification 150i may be a suggestion to delay maintenance operations by over a week to prevent any downtime during the period of time at the base station 160a. In some embodiments, the server 102 may generate one or more optimized configuration commands 104 to implement at least a portion of the possible modifications 150a-150c and/or to report the possible modifications 150a-150c.

In one or more embodiments, the possible modifications 150 may inform, trigger, and/or comprise concrete steps to plan constructions of new base stations 160 to provide a new area of coverage. In other embodiments, the possible modifications 150 may comprise suggestions to incorporate, replace, and/or update service providers using the base station 160a.

### Example Process to Analyze Communication Operations In Simulated Environments

FIG. 3 illustrate respective example flowchart of the process 300, in accordance with one or more embodiments. Modifications, additions, or omissions may be made to the process 300. The process 300 may include more, fewer, or other operations than those shown above. For example, operations may be performed in parallel or in any suitable order. While at times discussed as the server 102, one or more of the network components 118, one or more of the base stations 160, components of any of thereof, or any suitable system or components of the security system 100 may perform one or more operations of the process 300. For example, one or more operations of the process 300 may be implemented, at least in part, in the form of server instructions 132 of FIG. 1, stored on non-transitory, tangible, machine-readable media (e.g., server memory 130 of FIG. 1 operating as a non-transitory computer readable medium) that when run by one or more processors (e.g., the server processor 122 of FIG. 1) may cause the one or more processors to perform operations described in operations 302-326.

FIG. 3 illustrates an example flowchart of the process 300 to generate the optimized configuration commands 104 for a base station 160a, in accordance with one or more embodiments. In one or more embodiments, the process 300 starts at operation 302, where the server 102 performs communication operations in a communication network in accordance with existing configuration commands 136. As a non-limiting example, the communication operations may comprise transmission and/or reception operations at a cell site. At operation 304, the server 102 collects the device information 140 associated with the communication operations. In some embodiments, the device information 140 is collected from the base station 160a over a predefined (e.g., preconfigured or configured) time duration. In other embodiments, the device information 140 is collected from the base station 160a continuously or periodically over the predefined time duration. In yet other embodiments, the server 102 may store the device information 140 automatically in response to performing one or more communication operations (e.g., reception and/or transmissions of signals) with the base station 160a. Continuing with the aforementioned example, the cell site may be configured to collect the device information 140 from the cell site while the transmission and reception operations are performed. At operation 306, the server 102 determines one or more simulation parameters 156 corresponding to the device information 140. The server 102 is configured to identify the simulation parameters 156 as one or more indicators of a future performance of the transmission and reception operations at the cell site. The simulation parameters 156 may be elements that impact the transmission and/or reception operations at the cell site (e.g., length of use of antennas, resource assignments for transmission and/or reception, or foliage surrounding antennas at the cell site among others). At operation 308, the server 102 monitors the simulation parameters 156 based at least in part upon execution of the machine learning algorithm 146. The machine learning algorithm 146 may organize and analyze the information stored in the server memory 130. Herein, the server 102 performs at least one simulation while the machine learning algorithm 146 monitors changes over time in the at least one simulation. In the simulation, the machine learning algorithm predicts a performance of the cell site over time. At operation 310, the server 102 may analyze a simulated performance 154 of the base station 160a over a period of time. At this stage, in the previous example, the simulated performance 154 shows reception and transmission operations at the cell site over the period of time. In this regard, the simulated performance 154 shows any, some, or all possible changes to the transmission and reception operations. The number of changes shown may depend on a number of simulation parameters 156 tracked upon executing the machine learning algorithm 146. At operation 312, the server 102 may compare the simulated performance 154 to the expected performance 152.

The process 300 continues at operation 320, where the server 102 may determine whether the simulated performance 154 matches the expected performance 152. In this regard, the server 102 may compare the simulated performance 154 to the expected performance 152. If the server 102 determines that the simulated performance 154 does not match (e.g., different performance) the expected performance 152 (i.e., NO), the process 300 proceeds to operation 322. In the aforementioned non-limiting example, if a simulated performance 154 of the transmission and reception operations does not match a corresponding expected performance, the process 300 may continue to operations 322-326. In response, if the server determines that the simulated performance 154 matches (e.g., same performance) the expected performance 152 (i.e., YES), the process 300 returns to operation 302. In this case, in conjunction with operation 302, the server 102 performs new communication operations in the communication system 100 using the existing configuration commands 136. Continuing with the non-limiting example, if a simulated performance 154 of the transmission and reception operations matches a corresponding expected performance, the process 300 may return to operation 302. In this regard, the process 300 may restart for one or more new communication operations. The new communication operations simulated in this new cycle of the process 300 may be power allocation operations in the cell site.

In this case, the process 300 may conclude at operations 322-326, where the server 102 performs new communication operations in the communication system 100 using the optimized configuration commands 104. At operation 322, the server 102 is configured to determine possible modifications 150 to the configuration commands 136. For the aforementioned example, these modifications may comprise software modifications such as reallocating resources for transmission and reception operations and/or hardware modifications such as trimming foliage currently blocking antennas at the cell site. At operation 324, the server 102 is configured to generate one or more optimized configuration commands 104 based on the possible modifications 150. In this regard, the machine learning algorithm 146 may output the one or more artificial intelligence commands 148 to implement the optimized configuration commands 104. In this regard, optimized configuration commands 104 may be implemented in software and/or hardware modifications as discussed above. At operation 326, the server 102 may be configured to perform communication operations in the communication network in accordance with the optimized configuration commands 104. Continuing with the previous example, the server 102 is configured to perform the transmission and reception operations using the optimized configuration commands 104.

### SCOPE OF THE DISCLOSURE

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. An apparatus, comprising:
a memory, comprising:
a machine learning algorithm configured to analyze and structure information associated with one or more communication operations performed by the apparatus; and
a plurality of existing configuration commands configured to enable execution of the one or more communication operations; and
a processor communicatively coupled to the memory and configured to:
perform a first plurality of communication operations in accordance with the plurality of existing configuration commands;
determine a first plurality of simulation parameters based at least in part upon the first plurality of communication operations, the first plurality of simulation parameters being guidelines for a first simulated performance of the apparatus in a simulated environment;
in response to executing the machine learning algorithm, generate the first simulated performance of the apparatus over a first period of time in the simulated environment;
compare the first simulated performance to a first expected performance of the apparatus;
determine whether the first simulated performance matches the first expected performance;
in response to determining that the first simulated performance does not match the first expected performance, determine a first plurality of possible modifications to the plurality of existing configuration commands, the first plurality of possible modifications comprising possible updates to the plurality of existing configuration commands;
generate a first plurality of optimized configuration commands based at least in part upon the first plurality of possible modifications; and
in response to generating the first plurality of optimized configuration commands, perform a second plurality of communication operations in accordance with the first plurality of optimized configuration commands.

2. The apparatus of claim 1, wherein the processor is further configured to:
in conjunction with performing the first plurality of communication operations in accordance with the plurality of existing configuration commands, collect device information associated with the first plurality of communication operations, the device information comprising operational information of the apparatus and physical information of the apparatus; and
determine the first plurality of simulation parameters based at least in part upon the device information.

3. The apparatus of claim 2, wherein the operational information comprises at least one of Quality of Service (QOS), power usage, reception traffic, and transmission traffic associated with the first plurality of communication operations at the apparatus.

4. The apparatus of claim 2, wherein the physical information comprises at least one of information about local equipment, information about remote equipment, and area changes associated with the first plurality of communication operations at the apparatus.

5. The apparatus of claim 1, wherein the processor is further configured to:
perform a third plurality of communication operations in accordance with the plurality of existing configuration commands;
determine a second plurality of simulation parameters based at least in part upon the second plurality of communication operations, the second plurality of simulation parameters being guidelines for a second simulated performance of the apparatus in the simulated environment;
in response to executing the machine learning algorithm, generate the second simulated performance of the apparatus over a second period of time in the simulated environment;
compare the second simulated performance to a second expected performance of the apparatus;
determine whether the second simulated performance matches the second expected performance;
in response to determining that the second simulated performance does not match the second expected performance, determine a second plurality of possible modifications to the plurality of existing configuration commands, the second plurality of possible modifications comprising possible updates to the plurality of existing configuration commands;
generate a second plurality of optimized configuration commands based at least in part upon the second plurality of possible modifications; and
in response to generating the second plurality of optimized configuration commands, perform a fourth plurality of communication operations in accordance with the second plurality of optimized configuration commands.

6. The apparatus of claim 1, wherein the processor is further configured to:
perform a third plurality of communication operations in accordance with the plurality of existing configuration commands;
determine a second plurality of simulation parameters based at least in part upon the second plurality of communication operations, the second plurality of simulation parameters being guidelines for a second simulated performance of the apparatus in the simulated environment;
in response to executing the machine learning algorithm, generate the second simulated performance of the apparatus over a second period of time in the simulated environment;
compare the second simulated performance to a second expected performance of the apparatus;
determine whether the second simulated performance matches the second expected performance; and
in response to determining that the second simulated performance matches the second expected performance, perform a fourth plurality of communication operations in accordance with the plurality of existing configuration commands.

7. The apparatus of claim 1, wherein the simulated environment comprises a visual representation of a coverage area to be provided by the apparatus over the first period of time.

8. The apparatus of claim 7, wherein:
the visual representation is generated based at least in part upon mapping data;
the mapping data comprises location data, image data, and historic data associated with the coverage area; and
the location data comprises a location of the apparatus in the coverage area; and the image data comprises images of the location of the apparatus and one or more areas surrounding the location.

9. A method, comprising:
performing a first plurality of communication operations in accordance with a plurality of existing configuration commands configured to enable execution of one or more communication operations;
determining a first plurality of simulation parameters based at least in part upon the first plurality of communication operations, the first plurality of simulation parameters being guidelines for a first simulated performance of an apparatus in a simulated environment;
in response to executing a machine learning algorithm configured to analyze and structure information associated with one or more communication operations performed by the apparatus, generating the first simulated performance of the apparatus over a first period of time in the simulated environment;
comparing the first simulated performance to a first expected performance of the apparatus;
determining whether the first simulated performance matches the first expected performance;
in response to determining that the first simulated performance does not match the first expected performance, determining a first plurality of possible modifications to the plurality of existing configuration commands, the first plurality of possible modifications comprising possible updates to the plurality of existing configuration commands;
generating a first plurality of optimized configuration commands based at least in part upon the first plurality of possible modifications; and
in response to generating the first plurality of optimized configuration commands, performing a second plurality of communication operations in accordance with the first plurality of optimized configuration commands.

10. The method of claim 9, further comprising:
in conjunction with performing the first plurality of communication operations in accordance with the plurality of existing configuration commands, collecting device information associated with the first plurality of communication operations, the device information comprising operational information of the apparatus and physical information of the apparatus; and
determining the first plurality of simulation parameters based at least in part upon the device information.

11. The method of claim 10, wherein the operational information comprises at least one of Quality of Service (QOS), power usage, reception traffic, and transmission traffic associated with the first plurality of communication operations at the apparatus.

12. The method of claim 10, wherein the physical information comprises at least one of information about local equipment, information about remote equipment, and area changes associated with the first plurality of communication operations at the apparatus.

13. The method of claim 9, further comprising:
performing a third plurality of communication operations in accordance with the plurality of existing configuration commands;
determining a second plurality of simulation parameters based at least in part upon the second plurality of communication operations, the second plurality of simulation parameters being guidelines for a second simulated performance of the apparatus in the simulated environment;
in response to executing the machine learning algorithm, generating the second simulated performance of the apparatus over a second period of time in the simulated environment;
comparing the second simulated performance to a second expected performance of the apparatus;
determining whether the second simulated performance matches the second expected performance;
in response to determining that the second simulated performance does not match the second expected performance, determining a second plurality of possible modifications to the plurality of existing configuration commands, the second plurality of possible modifications comprising possible updates to the plurality of existing configuration commands;
generating a second plurality of optimized configuration commands based at least in part upon the second plurality of possible modifications; and
in response to generating the second plurality of optimized configuration commands, performing a fourth plurality of communication operations in accordance with the second plurality of optimized configuration commands.

14. The method of claim 9, further comprising:
performing a third plurality of communication operations in accordance with the plurality of existing configuration commands;
determining a second plurality of simulation parameters based at least in part upon the second plurality of communication operations, the second plurality of simulation parameters being guidelines for a second simulated performance of the apparatus in the simulated environment;
in response to executing the machine learning algorithm, generating the second simulated performance of the apparatus over a second period of time in the simulated environment;
comparing the second simulated performance to a second expected performance of the apparatus;
determining whether the second simulated performance matches the second expected performance; and
in response to determining that the second simulated performance matches the second expected performance, performing a fourth plurality of communication operations in accordance with the plurality of existing configuration commands.

15. The method of claim 9, wherein the simulated environment comprises a visual representation of a coverage area to be provided by the apparatus over the first period of time.

16. The method of claim 15, wherein:
the visual representation is generated based at least in part upon mapping data;
the mapping data comprises location data, image data, and historic data associated with the coverage area;
the location data comprises a location of the apparatus in the coverage area; and
the image data comprises images of the location of the apparatus and one or more areas surrounding the location.

17. A non-transitory computer readable medium storing instructions that when executed by a processor cause the processor to:
perform a first plurality of communication operations in accordance with a plurality of existing configuration commands configured to enable execution of one or more communication operations;
determine a first plurality of simulation parameters based at least in part upon the first plurality of communication operations, the first plurality of simulation parameters being guidelines for a first simulated performance of an apparatus in a simulated environment;
in response to executing a machine learning algorithm configured to analyze and structure information associated with one or more communication operations performed by the apparatus, generate the first simulated performance of the apparatus over a first period of time in the simulated environment;
compare the first simulated performance to a first expected performance of the apparatus;
determine whether the first simulated performance matches the first expected performance;
in response to determining that the first simulated performance does not match the first expected performance, determine a first plurality of possible modifications to the plurality of existing configuration commands, the first plurality of possible modifications comprising possible updates to the plurality of existing configuration commands;
generate a first plurality of optimized configuration commands based at least in part upon the first plurality of possible modifications; and
in response to generating the first plurality of optimized configuration commands, perform a second plurality of communication operations in accordance with the first plurality of optimized configuration commands.

18. The non-transitory computer readable medium of claim 17, wherein the instructions further cause the processor to:
in conjunction with performing the first plurality of communication operations in accordance with the plurality of existing configuration commands, collect device information associated with the first plurality of communication operations, the device information comprising operational information of the apparatus and physical information of the apparatus; and
determine the first plurality of simulation parameters based at least in part upon the device information.

19. The non-transitory computer readable medium of claim 18, wherein the operational information comprises at least one of Quality of Service (QOS), power usage, reception traffic, and transmission traffic associated with the first plurality of communication operations at the apparatus.

20. The non-transitory computer readable medium of claim 18, wherein the physical information comprises at least one of information about local equipment, information about remote equipment, and area changes associated with the first plurality of communication operations at the apparatus.
